(19) United States
(12) Patent Application Publication
(10) Pub. No.: US 2009/0001114 A1
(43) Pub. Date: Jan. 1, 2009

(54) SADDLEBAG MOUNTING SYSTEM FOR A MOTORCYCLE

(75) Inventors: Jeffary R. Sonnetag, Waukesha, WI (US); Frederich H. Knoch, Racine, WI (US); Douglas D. Clarkson, Colgate, WI (US)

Correspondence Address: MICHAEL BEST & FRIEDRICH LLP, 100 E WISCONSIN AVENUE, Suite 3300, MILWAUKEE, WI, 53202, US

(73) Assignee: Harley-Davidson Motor Company Group, Inc., Milwaukee, WI (US)

(21) Appl. No.: 12/147,684

(22) Filed: Jun. 27, 2008

Related U.S. Application Data
(60) Provisional application No. 60/947,153, filed on Jun. 29, 2007.

(51) Int. Cl. B62J 9/00

(52) U.S. Cl. 224/413

(57) ABSTRACT

A saddlebag mounting system for use with a motorcycle that includes a frame having a mounting location for coupling a footpeg to the motorcycle. The saddlebag mounting system includes a first bracket configured to securely attach the mounting location, a second bracket removably coupled to the first bracket, and a saddlebag coupled to the second bracket such that uncoupling the second bracket from the first bracket disconnects the saddlebag and the second bracket from the motorcycle and leaves the first bracket attached to the frame.

### CROSS-REFERENCE TO RELATED APPLICATIONS

This application claims priority to U.S. Provisional Patent Application No. 60/947,153, filed Jun. 29, 2007, the entire contents of which are hereby incorporated by reference.

### BACKGROUND

The present invention relates to a motorcycle, and more particularly to a saddlebag mounting system for a motorcycle.

Motorcycles can include saddlebags that are used by the rider of the motorcycle to store items on the motorcycle. Saddlebags are commonly mounted to corresponding saddlebag brackets. The saddlebags and saddlebag brackets are typically secured to opposing sides of the motorcycle. The saddlebags can be mounted to the motorcycle to permit removal of the saddlebags from the motorcycle in order to change the appearance of the motorcycle and to allow the user to transport items away from the motorcycle in the saddlebags.

### SUMMARY

In one embodiment, the invention provides a saddlebag mounting system for use with a motorcycle. The motorcycle includes a frame having a mounting location for coupling a footpeg to the motorcycle. The saddlebag mounting system includes a first bracket configured to securely attach to the mounting location, a second bracket removably coupled to the first bracket, and a saddlebag coupled to the second bracket such that uncoupling the second bracket from the first bracket disconnects the saddlebag and the second bracket from the motorcycle and leaves the first bracket attached to the frame.

In another embodiment, the invention provides a motorcycle including a frame having a swing arm and a first bracket separate from and securely attached to the frame. The first bracket includes a first leg generally aligned with the swing arm. The motorcycle also includes a second bracket removably coupled to the first bracket and a saddlebag coupled to the second bracket such that uncoupling the second bracket from the first bracket disconnects the saddlebag and the second bracket from the motorcycle and leaves the first bracket attached to the frame.

In yet another embodiment, the invention provides a saddlebag mounting system for use with a motorcycle. The motorcycle includes a frame and a first bracket attached to the frame. The saddlebag mounting system includes a saddlebag and a second bracket secured to the saddlebag. The second bracket includes an opening configured to receive a portion of the first bracket and an engagement member configured to engage the first bracket. The engagement member is movable relative to the opening between an open position to disengage the first bracket and a closed position to engage the first bracket.

Other aspects of the invention will become apparent by consideration of the detailed description and accompanying drawings.

### BRIEF DESCRIPTION OF THE DRAWINGS

FIG. 1 is a side view of a motorcycle including a saddlebag mounting system according to an embodiment of the invention.

FIG. 2 is a side view of a portion of the motorcycle shown in FIG. 1 without a saddlebag attached.

FIG. 3 is a perspective view of the saddlebag mounting system shown in FIG. 1.

FIG. 4 is a rear view of the saddlebag mounting system shown in FIG. 1.

FIG. 5 is an exploded perspective view of the saddlebag mounting system shown in FIG. 1.

FIG. 6 is a bottom perspective view of the saddlebag mounting system shown in FIG. 1 with the saddlebag disconnected from a leave-on bracket.

FIG. 7 is a front perspective view of a frame of the motorcycle including a passenger seat and the saddlebag mounting system.

FIG. 8 is a rear perspective view of the frame of the motorcycle shown in FIG. 7.

FIG. 9 is an exploded view of the saddlebag mounting system shown in FIG. 7.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

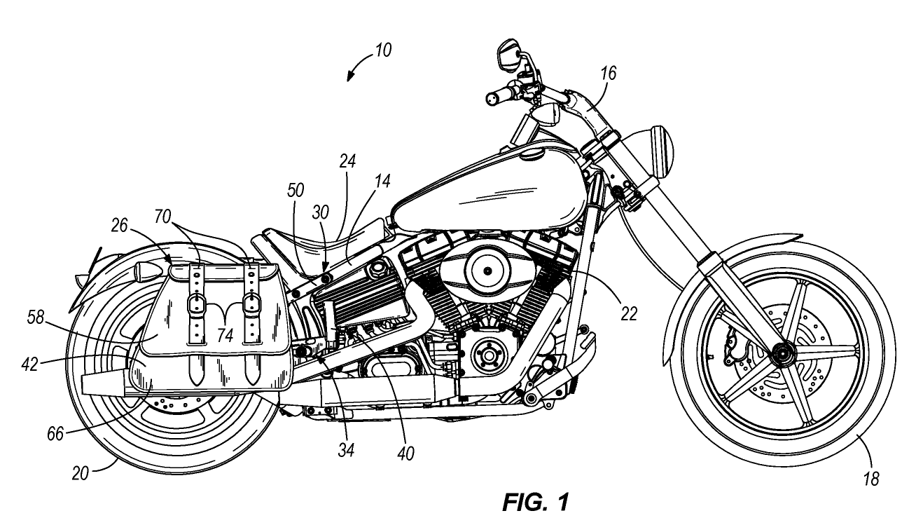

FIG. 1 illustrates a motorcycle 10 including a frame 14, a steering or handlebar assembly 16 pivotally mounted to a forward portion of the frame 14, a front wheel 18 rotatably mounted to an end of the steering assembly 16, and a rear wheel 20 rotatably mounted to a rearward portion of the frame 14. An engine/transmission assembly 22 is mounted to the frame 14 and is coupled to the rear wheel 20 to drive the rear wheel 20. A seat assembly 24 is coupled to the frame 14 to support a driver. The driver controls the engine/transmission assembly 22 to drive the rear wheel 20 and, thereby, propel the motorcycle 10. The driver pivots the steering assembly 16 to turn the front wheel 18 and steer the motorcycle 10 while the motorcycle 10 is moving.

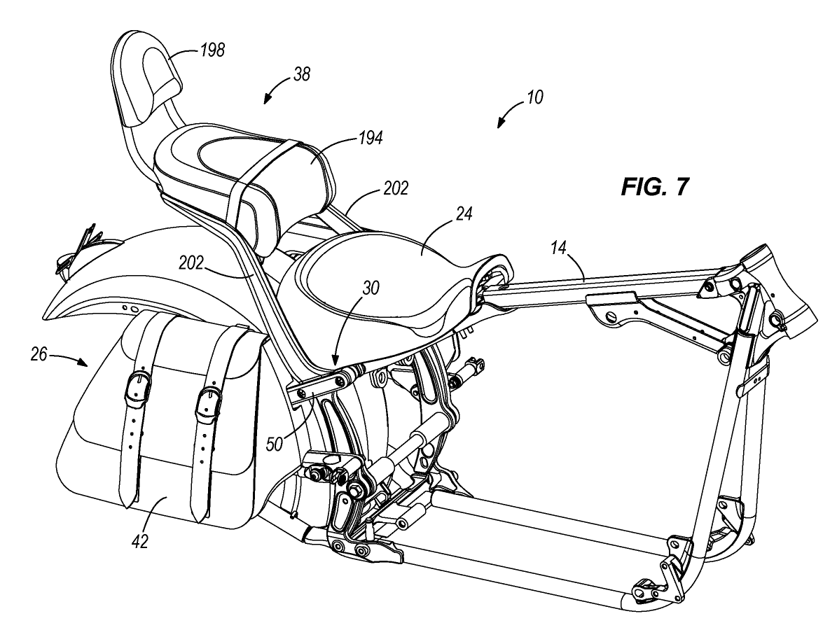

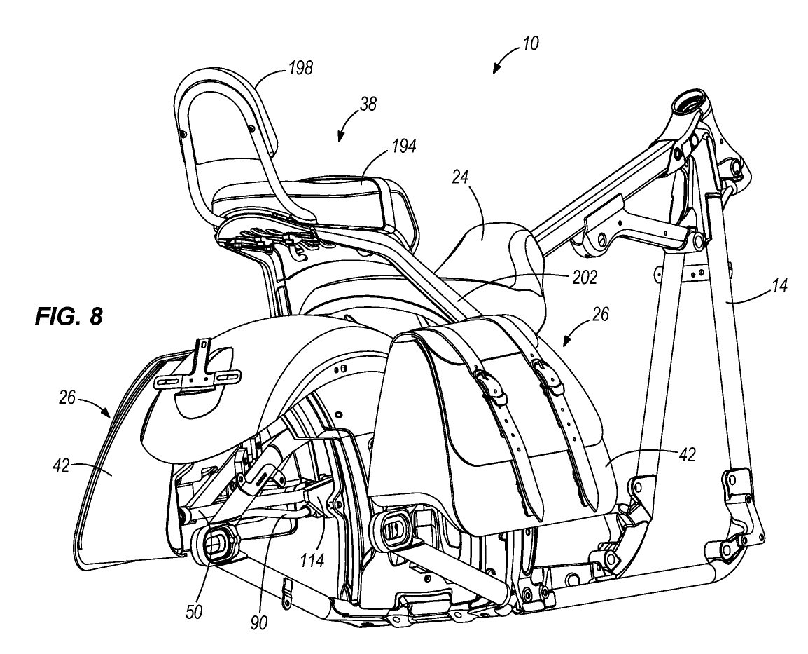

In the illustrated embodiment, the motorcycle 10 includes a saddlebag mounting system 26 coupled to a side of the motorcycle frame 14. The illustrated saddlebag mounting system 26 is coupled to the rearward portion of the frame 14 at a frame joint 30 and a passenger footpeg mounting location 34. The frame joint 30 is an existing mounting area on the motorcycle frame 14 to couple, for example, a luggage rack and/or a passenger seat 38 to the frame 14, as shown in FIGS. 7 and 8. In some embodiments, the frame joint 30 may be defined by threaded holes in a sidewall of a non-jointed portion of the frame 14. Additionally or alternatively, the frame joint 30 can be used to couple a fender strut to the frame 14 for supporting a fender over the rear wheel 20 of the motorcycle 10. The footpeg mounting location 34 facilitates coupling of a footpeg 40 to the frame 14. In the illustrated embodiment, only one saddlebag mounting system 26 is shown coupled to one side of the frame 14. However, the motorcycle 10 includes a second saddlebag mounting system that is substantially similar, but mirrored relative to the illustrated saddlebag mounting system 26 and that is installed/attached to the other side of the frame 14 in a substantially similar manner.

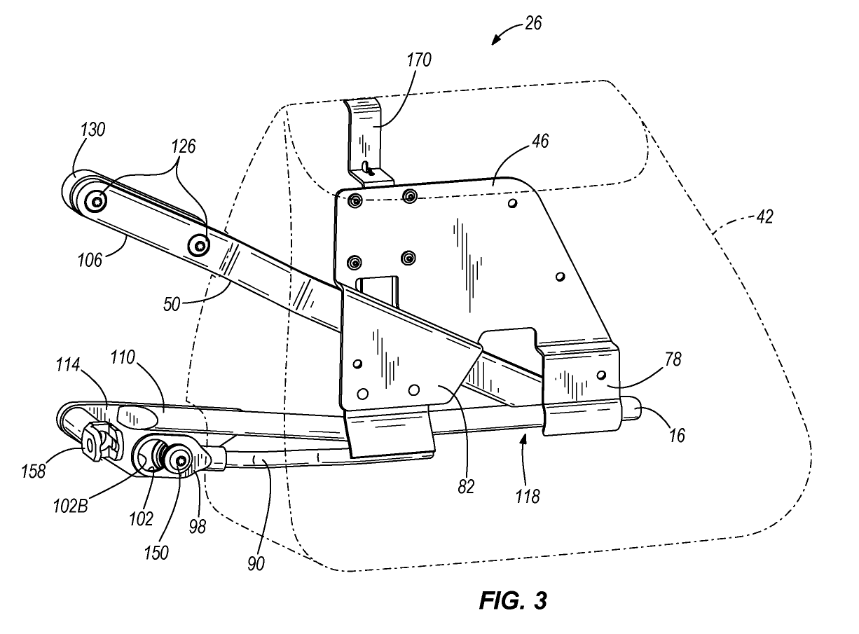

As shown in FIGS. 3-6, the saddlebag mounting system 26 includes a saddlebag 42, a saddlebag bracket 46, a leave-on bracket 50, and a release mechanism 54. In FIGS. 3-6, the saddlebag 42 is transparently shown to facilitate description and illustration of the other components of the saddlebag mounting system 26.

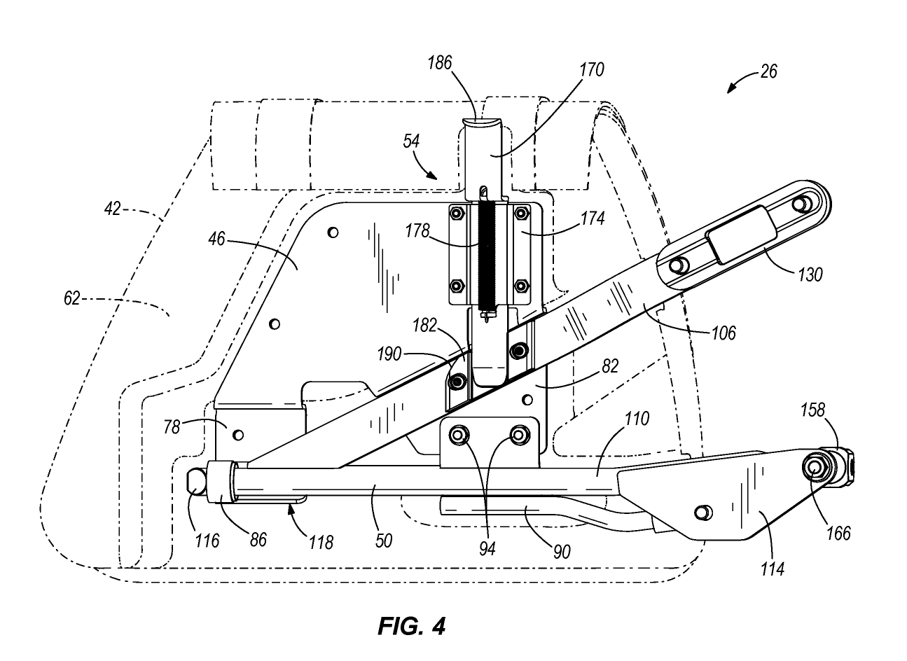

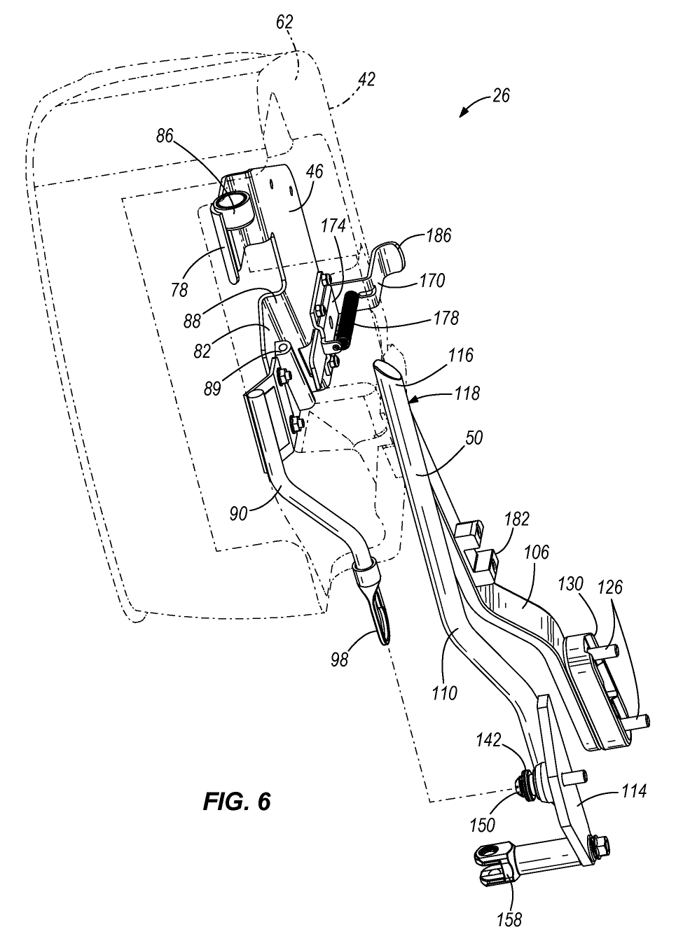

Referring to FIG. 1, the illustrated saddlebag 42 is composed of leather and defines a cavity to store items for a rider. In other embodiments, the saddlebag 42 may be composed of a rigid fabric or another suitable rigid, semi-rigid, or non-rigid material. The illustrated saddlebag 42 includes a flap 58, or cover, that is coupled (e.g., stitched) to a back wall 62 (FIGS. 4 and 6) of the saddlebag 42 to allow access to the cavity. In some embodiments, the flap 58 may be coupled to the back wall 62 with a hinge. In the illustrated embodiment, the flap 58 is secured in a closed, or covered, position on a front wall 66 of the saddlebag 42 by a pair of straps 70 and corresponding buckles 74. In other embodiments, the flap 58 may be secured in the closed position with a hook and loop fastener (e.g., VELCRO), clips, or the like.

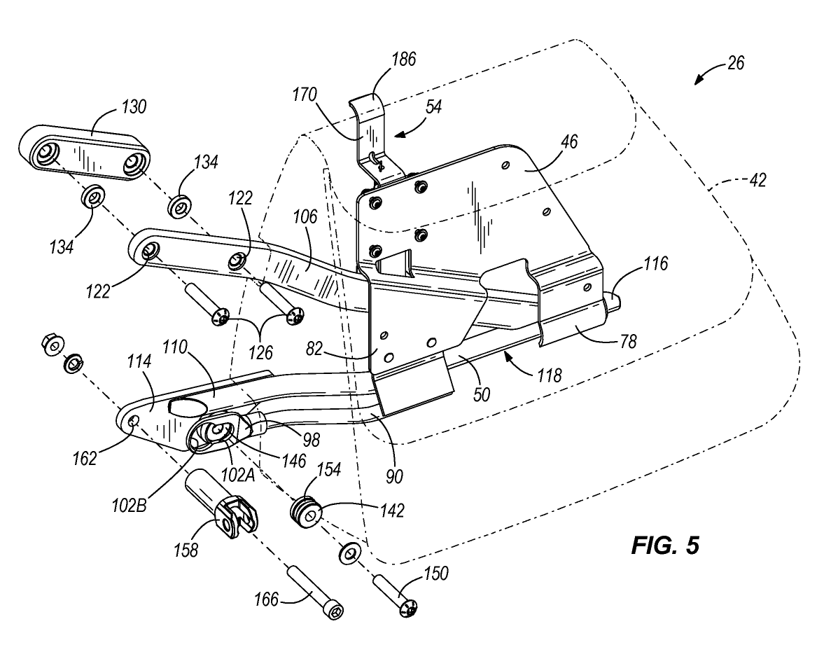

As shown in FIGS. 3-6, the saddlebag bracket 46 is coupled to the back wall 62 of the saddlebag 42 and attaches the saddlebag 42 to the leave-on bracket 50. In the illustrated embodiment, the saddlebag bracket 46 is a single plate that includes first and second engagement portions 78, 82. As shown in FIGS. 5 and 6, the first and second engagement portions 78, 82 are recessed inwardly relative to the saddlebag 42 by bending. In other embodiments, the engagement portions 78, 82 may be separate plates coupled to the saddlebag bracket 46.

Referring to FIGS. 4 and 6, the first engagement portion 78 includes an engagement ring 86 defining an opening configured to receive a portion of the leave-on bracket 50. The ring 86 slides into and out of engagement with a portion of the leave-on bracket 50 to inhibit movement of the saddlebag bracket 46 away from the frame 14. In some embodiments, the inside of the ring 86 that defines the opening may be lined with a bushing (e.g., a plastic bushing, a rubber gasket, etc.) to increase friction between the ring 86 and the leave-on bracket 50 and to reduce scratches that may form on the leave-on bracket 50 when the ring 86 slides into engagement. It should be noted that the opening can be defined by any suitable structure that receives a portion of the leave-on bracket 50, including structures other than the ring 86.

The second engagement portion 82 is designed to rest on a portion of the leave-on bracket 50. As shown in FIG. 6, a bent surface 88 of the saddlebag bracket 46 transitions to the second engagement portion 82. The second engagement portion 82 includes a support 89 spaced apart from and parallel to the surface 88 such that a portion of the leave-on bracket 50 is captured between the surface 88 and the support 89. The support 89 is composed of an elastomeric material to increase friction and reduce scratching and rattling between the saddlebag bracket 46 and the leave-on bracket 50. In some embodiments, the surface 88 can include a resilient pad or other resilient coating to also increase friction and reduce scratching and rattling between the saddlebag bracket 46 and the leave-on bracket 50.

The second engagement portion 82 also includes an arm 90 coupled to and extending forward (i.e., toward the front wheel of the motorcycle 10) from the saddlebag bracket 46. In the illustrated embodiment, the arm 90 is coupled to the bracket 46 by fasteners 94. In other embodiments, the arm 90 may be formed as a single piece with the bracket 46 or may be attached the bracket 46 with different coupling means. As shown in FIGS. 3 and 5, an engagement plate 98 is coupled to an end of the arm 90 opposite from the bracket 46 and includes a keyhole slot 102. The keyhole slot 102 engages a portion of the leave-on bracket 50 to further facilitate coupling of the saddlebag bracket 46 to the leave-on bracket 50 while inhibiting movement of the saddlebag bracket 46 away from the frame 14.

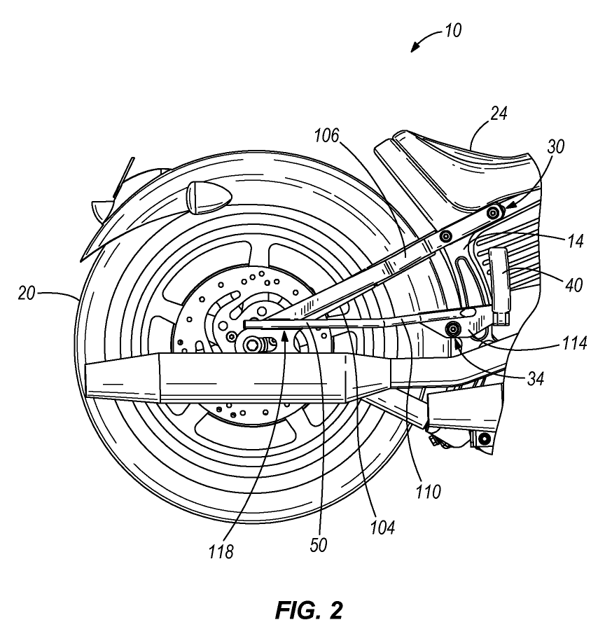

The leave-on bracket 50 is generally V-shaped and is configured to couple to the frame 14 at the frame joint 30 and at the footpeg mounting location 34. As shown in FIG. 2, the leave-on bracket 50 is chrome plated and at least partially follows established frame lines of the motorcycle 10 such that the leave-on bracket 50 is aesthetically pleasing when the saddlebag 42 and the saddlebag bracket 46 are removed. For example, a portion of the leave-on bracket 50 is aligned with (e.g., substantially laterally overlies or covers) a swing arm 104 (FIG. 2) of the motorcycle 10. In other embodiments, the leave-on bracket 50 may be painted or otherwise coated to match the appearance of the motorcycle 10.

Referring to FIGS. 3-6, the illustrated leave-on bracket 50 includes a generally flat leg 106 defining one half of the V-shape, a generally round leg 110 defining the other half of the V-shape, and a mount plate 114 coupled to one end of the round leg 110. The flat leg 106 is connected to the round leg 110 such that a relatively small portion 116 of the round leg 110 extends past a connecting area 118 of the legs 106, 110. Two apertures 122 positioned on an end of the flat leg 106 opposite from the connecting area 118 are configured to receive fasteners 126 (e.g., button head capscrews) to secure the leave-on bracket 50 to the frame 14 at the joint 30. In the illustrated embodiment, a larger spacer 130 and two smaller washer-type spacers 134 are positioned between the joint 30 and the flat leg 106 to maintain proper spacing between the frame 14 and the saddlebag mounting system 26. In embodiments where a luggage rack and/or a rear seat is present (such as the embodiment shown in FIGS. 7-9 and further described below), one or more of the spacers 130, 134 may be omitted.

As shown in FIG. 2, the flat leg 106 of the leave-on bracket 50 is substantially aligned with the swing arm 104 of the motorcycle 10. In such an embodiment, the flat leg 106 substantially laterally covers the swing arm 104 when the saddlebag 42 is removed such that the flat leg 106 appears to be the swing arm 14. The flat leg 106 thereby matches the frame lines of the motorcycle 10 to maintain the appearance of the motorcycle 10 when the saddlebag 42 and the saddlebag bracket 46 are disconnected from the leave-on bracket 50.

The illustrated round leg 110 is sized to be about the same length as the flat leg 106 and to fit within the engagement ring 86 of the saddlebag bracket 46. As shown in FIG. 4, the small portion 116 of the round leg 110 extends beyond the connecting area 118. This small portion 116 is tapered to facilitate reception of the round leg 110 within the engagement ring 86.

The mount plate 114 is coupled (e.g., welded, brazed, glued, fastened) to an end of the round leg 110 opposite the connecting area 118 to secure the leave-on bracket 50 at the footpeg mounting location 34. In the illustrated embodiment, the mount plate 114 includes a docking point 142, a docking point spacer 146, and a fastener 150 (e.g., a button head capscrew). The docking point 142 is sized to fit within the keyhole slot 102 and includes a groove 154 such that the docking point 142 may securely engage a smaller portion 102A of the slot 102. The docking point spacer 146 spaces the docking point 142 slightly apart from the mount plate 114 to prevent rubbing between the engagement plate 98 and the mount plate 114. The fastener 150 secures the docking point 142 and the docking point spacer 146 to the mount plate 114.

The mount plate 114 is configured to relocate the footpeg 40 (FIG. 1) to a slightly offset location. In the illustrated embodiment, the mount plate 114 relocates the footpeg 40, and a clevis pin 158 of the footpeg 40, approximately one inch upward (i.e., away from the ground) and two inches forward (i.e., toward the front wheel 18 of the motorcycle 10). The illustrated mount plate 114 includes an aperture 162 configured to receive a fastener 166 (e.g., a socket head capscrew) to secure the clevis pin 158 of the footpeg 40 to the mount plate 114 at this offset location.

The illustrated release mechanism 54, or blade mechanism, includes an engagement member in the form of a blade 170, a guide bracket 174 coupled to the saddlebag bracket 46, a spring 178 coupled between the blade 170 and the guide bracket 174, and a receiving bracket 182 coupled to the leave-on bracket 50. The blade 170 is slidably received within the guide bracket 174 and is biased downwardly by the spring 178. In the illustrated embodiment, the blade 170 includes a lip 186 to facilitate engagement and actuation (e.g., lifting) of the blade 170 by a user. The guide bracket 174 and the receiving bracket 182 are coupled to the saddlebag bracket 46 and the leave-on bracket 50, respectively, such that when the saddlebag bracket 46 is coupled to the leave-on bracket 50, the guide and receiving brackets 174, 182 are substantially aligned. The blade 170 may then slide within the guide bracket 174 and into the receiving bracket 182 to secure the saddlebag bracket 46 to the leave-on bracket 50. When the receiving bracket 182 receives a portion of the blade 170, the blade 170 inhibits sliding of the saddlebag bracket 46 relative to the leave-on bracket 50 along and apart from the legs 106, 110.

As shown in FIGS. 4 and 6, the receiving bracket 182 includes a rounded corner 190. The rounded corner 190 facilitates attachment of the saddlebag bracket 46 to the leave-on bracket 50 by providing a camming surface that pushes (e.g., lifts) the blade 170 against the bias of the spring 178. The rounded corner 190 facilitates movement of the blade 170 into a position that clears the receiving bracket 182 when the saddlebag bracket 46 is slid onto the leave-on bracket 50.

To install the leave-on bracket 50 on the frame 14, the footpeg 40 (FIG. 1), if attached, is removed from the footpeg mounting location 34 and any fasteners or covers are removed from the joint 30. The flat leg 106 is aligned with the joint 30 with the larger spacer 130 and the small spacers 134 positioned therebetween. The corresponding fasteners 126 are then inserted through the apertures 122 in the flat leg 106 and the spacers 130, 134 and into the joint 30 to secure the flat leg 106 to the motorcycle frame 14.

Prior to, at the same time, or after aligning/securing the flag leg 106 to the frame joint 30, the mount plate 114 is aligned with the footpeg mounting location 34 such that the docking point 142 and the docking point spacer 146 generally align with a hole in the footpeg mounting location 34 that was used to support the clevis pin 158. The corresponding fastener 150 is then inserted through the docking point 142, the docking point spacer 146, and the mount plate 114 to secure the mount plate 114 to the motorcycle frame 14. If desired, the clevis pin 158 of the footpeg 40 is reinstalled to the mount plate 114 at the slightly offset location defined by the aperture 162. The corresponding fastener 166 is then inserted through the clevis pin 158 and the mount plate 114 to secure the clevis pin 158 to the mount plate 114.

To attach the saddlebag 42 and the saddlebag bracket 46 to the leave-on bracket 50, the engagement ring 86 is aligned with the small portion 138 of the round leg 110 and the docking point 142 is partially inserted through a larger portion 102B of the keyhole slot 102. The saddlebag 42 and the saddlebag bracket 46 are then slid along the round leg 110 such that the engagement ring 86 frictionally engages the round leg 110 and the docking point 142 engages the smaller portion 102A of the keyhole slot 102. As the saddlebag 42 and the saddlebag bracket 46 are slid along the leave-on bracket 50, the blade 170 of the release mechanism 54 lifts when it contacts the rounded corner 190 of the receiving bracket 182. If necessary, a user may manually lift the blade 170 to help the blade 170 clear the rounded corner 190 of the receiving bracket 182. When the saddlebag 42 and the saddlebag bracket 46 are slid onto the leave-on bracket 50, the blade 170 is biased downwardly by the spring 178 into the receiving bracket 182 to securely hold the saddlebag 42 and the saddlebag bracket 46 relative to the motorcycle frame 14. In such an arrangement, the engagement ring 86 and the docking point 142 inhibit movement of the saddlebag 42 and the saddlebag bracket 46 away from the frame 14, while the release mechanism 54 inhibits sliding and/or rotation of the saddlebag 42 and the saddlebag bracket 46 relative to the leave-on bracket 50.

To remove the saddlebag 42 and the saddlebag bracket 46 from the leave-on bracket 50, the above operation is performed in reverse. A user lifts the blade 170 out of the receiving bracket 182 such that the blade 170 may clear the rounded corner 190 of the receiving bracket 182. The saddlebag 42 and the saddlebag bracket 46 are then slid in an opposite direction such that the engagement ring 86 slides off of the round leg 110 and the docking point 142 slides out of the smaller portion 102A of the keyhole slot 102. The saddlebag 42 and the saddlebag bracket 46 are then pulled away from the leave-on bracket 50 and, thereby, the motorcycle 10.

FIGS. 7 and 8 illustrate the motorcycle 10 with a saddlebag mounting system 26 coupled to each side of the frame 14. In the illustrated embodiment, the motorcycle 10 also includes the passenger seat 38 having a pillion 194, a backrest 198, and support arms 202 coupling the pillion 194 and the backrest 198 to the frame 14. The support arms 202 are coupled to the motorcycle frame 14 at the corresponding frame joints 30 such that the saddlebag mounting systems 26 couple to the joints 30 through the support arms 202. In some constructions, the passenger seat 38 may be a motorcycle trick seat coupled to the joint 30. In either arrangement, spacing between the saddlebag mounting systems 26 and the frame 14 is slightly different from the arrangement shown in FIGS. 1-6.

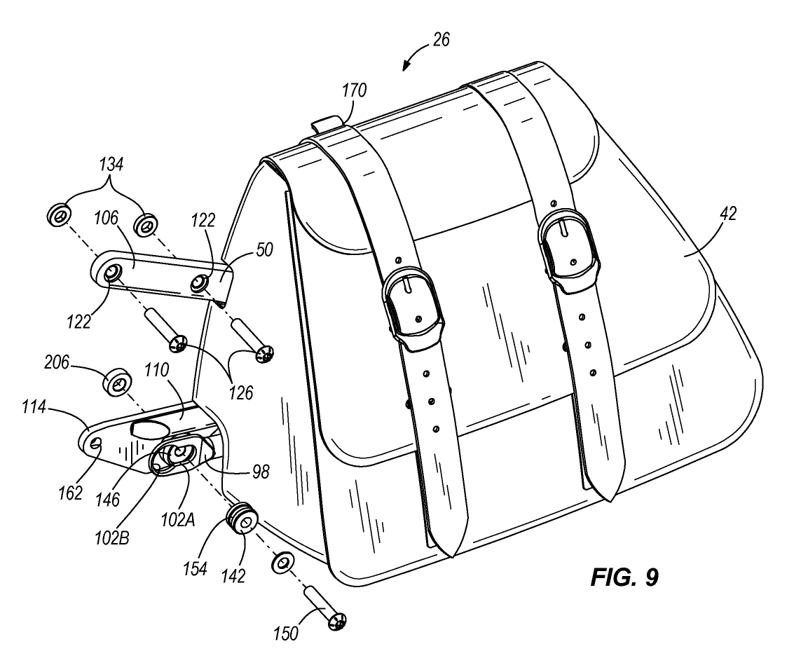

Referring to FIG. 9, the components to mount the saddlebag mounting system 26 to the motorcycle 14 that includes the passenger seat 38 are shown. In the illustrated embodiment, the larger spacer 130 between the joint 30 and the flat leg 106 of the leave-on bracket 50 is omitted due to the spacing provided by the support arms 202 of the passenger seat 38. However, an additional spacer 206 is provided between the mount plate 114 and the footpeg mounting location 34 to accommodate an increased space at that location. Although the clevis pin 158 is not shown in FIG. 9, it should be readily apparent that the footpeg 40 may still be mounted at the aperture 162 in the mount plate 114.

The illustrated saddlebag mounting system 26 provides a two point mounting structure that replaces the function of fender struts in mounting saddlebags to a motorcycle. Instead, the saddlebag mounting system 26 mounts to an existing frame joint and a passenger footpeg mounting location to securely attach a saddlebag to a motorcycle. The saddlebag mounting system 26 is also configured to be used with or without a passenger seat and provides the option of relocating the footpeg a relatively small distance from its original position.

In addition, the saddlebag mounting system 26 is cosmetically stylized (e.g., chrome plated) such that even when a portion of the system 26 is left on a motorcycle (e.g., the leave-on bracket 50), the overall aesthetic appearance of the motorcycle is not diminished.

Various features and advantages are set forth in the following claims.

1. A saddlebag mounting system for use with a motorcycle, the motorcycle including a frame having a mounting location for coupling a footpeg to the frame, the saddlebag mounting system comprising:
a first bracket configured to securely attach to the mounting location;
a second bracket removably coupled to the first bracket; and
a saddlebag coupled to the second bracket such that uncoupling the second bracket from the first bracket disconnects the saddlebag and the second bracket from the motorcycle and leaves the first bracket attached to the frame.

2. The saddlebag mounting system of claim 1, wherein the motorcycle includes a clevis pin to couple the footpeg to the frame at the mounting location, wherein the first bracket includes a plate configured to couple to the mounting location, and wherein the plate is configured to relocate the clevis pin relative to the mounting location.

3. The saddlebag mounting system of claim 2, wherein the plate is configured to relocate the clevis pin approximately one inch upward and two inches forward along the frame of the motorcycle.

4. The saddlebag mounting system of claim 1, wherein the frame includes a joint configured to couple at least one of a passenger seat and a luggage rack to the frame, and wherein the first bracket is also configured to securely attach to the joint.

5. The saddlebag mounting system of claim 1, further comprising a release mechanism coupled to one of the first bracket and the second bracket, wherein the release mechanism is operable to engage the other of the first bracket and the second bracket to releasably secure the second bracket to the first bracket.

6. The saddlebag mounting system of claim 5, wherein the release mechanism is coupled to the second bracket and includes an engagement member, and wherein the first bracket receives a portion of the engagement member to secure the second bracket relative to the first bracket.

7. The saddlebag mounting system of claim 6, wherein the release mechanism further includes a spring to bias the engagement member into engagement with the first bracket.

8. The saddlebag mounting system of claim 1, wherein the second bracket includes an opening, and wherein the opening receives a portion of the first bracket to couple the second bracket to the first bracket.

9. The saddlebag mounting system of claim 1, wherein the first bracket includes a docking point having a groove and the second bracket includes a keyhole slot, and wherein the keyhole slot receives the docking point and the groove receives a portion of the second bracket adjacent to the keyhole slot to couple the second bracket to the first bracket.

10. A motorcycle comprising:
a frame including a swing arm;
a first bracket separate from and securely attached to the frame, the first bracket including a first leg generally aligned with the swing arm;
a second bracket removably coupled to the first bracket; and
a saddlebag coupled to the second bracket such that uncoupling the second bracket from the first bracket disconnects the saddlebag and the second bracket from the motorcycle and leaves the first bracket attached to the frame.

11. The motorcycle of claim 10, wherein the first leg is secured to the frame at a joint, and wherein the first bracket includes a second leg secured to the frame at a footpeg mounting location.

12. The motorcycle of claim 11, further comprising a clevis pin for coupling a footpeg to the frame at the footpeg mounting location, wherein the first bracket includes a plate coupled to the footpeg mounting location to secure the second leg to the frame, and wherein the plate relocates the clevis pin relative to the footpeg mounting location.

13. The motorcycle of claim 11, wherein the second bracket includes an opening, and wherein the opening receives a portion of the second leg to couple the second bracket to the first bracket.

14. The motorcycle of claim 10, further comprising a release mechanism including an engagement member coupled to the second bracket and a spring coupled between the engagement member and the second bracket, wherein the first bracket receives a portion of the engagement member to couple the second bracket to the first bracket, and wherein the spring biases the engagement member into engagement with the first bracket.

15. The motorcycle of claim 10, wherein the first bracket includes a docking point having a groove and the second bracket includes a keyhole slot, and wherein the keyhole slot receives the docking point and the groove receives a portion of the second bracket adjacent to the keyhole slot to couple the second bracket to the first bracket.

16. A saddlebag mounting system for use with a motorcycle, the motorcycle including a frame and a first bracket attached to the frame, the saddlebag mounting system comprising:
a saddlebag; and
a second bracket secured to the saddlebag, the second bracket including an opening configured to receive a portion of the first bracket and an engagement member configured to engage the first bracket, the engagement member being movable relative to the opening between an open position to disengage the first bracket and a closed position to engage the first bracket.

17. The saddlebag mounting system of claim 16, wherein the second bracket includes a spring to bias the engagement member toward the closed position.

18. The saddlebag mounting system of claim 16, wherein the second bracket includes a bent surface, and wherein the bent surface is configured to rest on a portion of the first bracket.

19. The saddlebag mounting system of claim 16, wherein the second bracket includes an arm having a first end portion and a second end portion, and wherein the first end portion is coupled to the second bracket and the second end portion is configured to couple to the first bracket.

20. The saddlebag mounting system of claim 16, wherein the second bracket includes a plate coupled to the second end portion of the arm, and wherein the plate defines a keyhole slot configured to receive a portion of the first bracket to couple the arm to the first bracket.
